(19) United States
(12) Patent Application Publication
(10) Pub. No.: US 2005/0029339 A1
(43) Pub. Date: Feb. 10, 2005

(54) Systems, methods and devices for data exchange

(76) Inventor: Craig A. Wilensky, Ben Salem, PA (US)

Correspondence Address: EDWARDS & ANGELL, LLP, P.O. BOX 55874, BOSTON, MA, 02205, US

(21) Appl. No.: 10/778,595

(22) Filed: Feb. 13, 2004

Related U.S. Application Data
(60) Provisional application No. 60/447,609, filed on Feb. 13, 2003.

(51) Int. Cl. G06F 17/00

(52) U.S. Cl. 235/375

(57) ABSTRACT

The present invention features systems, methods and devices for exchanging data such as in a direct store delivery type of environment and more particularly such systems, methods and devices that utilize wireless or non-wireless communication techniques. In further embodiments, such systems, methods and devices, further include providing the capability of printing the transaction that can be used for proof of delivery. The present more particularly features a data transfer and communications device that provides an interface between a second device disposed at the point of delivery and a first device used by the delivery driver. In further embodiments, such a communications device is further configured and arranged so as to include a mechanism for printing the transaction for proof of delivery.

This application claims the benefit of U.S. Provisional Application Ser. No. 60/447,609 filed Feb. 13, 2003, the teachings of which are incorporated herein by reference.

### FIELD OF INVENTION

The present invention relates to systems, methods and devices for data exchange, more particularly systems, methods and devices for data exchange in a direct store delivery type of environment and more specifically to systems, methods and devices for data exchange in a direct store delivery type of environment that utilize one of wireless or non-wireless communication techniques.

### BACKGROUND OF THE INVENTION

In the Direct Store Delivery (DSD) type of environment, such as, but not limited to beverage, bakery and snack goods, the goods typically are delivered to the retailer or other receiver by a delivery person, and unloaded at the delivery site. In conjunction with the delivery and unloading, information regarding the goods being delivered needs to be transferred to the recipient as well as the delivery person receiving an acknowledgement in the form of a receipt for example, of the goods that were delivered. There has been created a Wireless Data Exchange/Uniform Communications Standard (DEX/UCS), that defines a standard to transfer product information between a retailers and/or vending computer system and a delivery driver's Handheld computer or Data Collector at the point of delivery. More specifically, DEX/UCS is typically used for the companies that do DSD (Direct Store Delivery) such as, but not limited to beverage, bakery and snack goods.

In such cases, the delivery person uses a handheld computer to input sales delivery, returns, cash receipts, expenses and inventory transactions at the customers' locations or the point of delivery (e.g., customer's warehouse). This method of computerized delivery and data transfer provides the benefit of faster back door check-ins, reconciliation's, returns, error reduction, acceptance, detailed cash receipts and adjustments. Such techniques, however, are necessarily limited by the physical constraints imposed by methodologies and equipment presently being used.

For example, a retailer must provide a resident computer at the docking door or in-store locations so as to accept the delivery drivers' handheld computer's DEX/UCS data transfer. This is very costly, time consuming with high maintenance requirements. In addition, the delivery drivers also may not have a means for printing the transaction (i.e., proof of delivery) so that the retailers' personnel can validate the delivery at such locations.

It thus would be desirable to provide devices, systems and methods that further enhance the DEX/UCS process by removing the physical restrictions of the data transfer between a delivery persons' handheld computer and the retailer and/or vending companies computer systems. Such devices and systems and methods are such that the people having the same skill sets as those presently delivering and receiving such goods can use them.

### SUMMARY OF THE INVENTION

The present invention features systems and devices for data exchange for exchanging data in a direct store delivery type of environment and more particularly specifically to such systems and methods for data exchange in a direct store delivery type of environment that utilize one of wireless or non-wireless communication techniques. Also featured are devices that embody the methodology for such data exchanges, more particularly data exchanges using wireless or non-wireless communications techniques. In further embodiments, such systems, methods and devices, further include providing the capability of printing the transaction that can be used for proof of delivery.

The present invention more particularly features a data transfer and communications device that provides an interface between the computer system at the point of delivery and the delivery driver's handheld computer. Such a communications device thus can supplant the typical need for the so-called back-door and/or in-store computer that is dedicated or provided to accept such transactions and data transfers. In further embodiments, such a communications device is further configured and arranged so as to include a mechanism for printing the transaction for proof of delivery, preferably responsive to instructions from the retailer's or recipient's computer system following the computer systems receipt of the data transferred from the delivery driver's handheld computer.

In more particular embodiments, the data transfer and communications device is configured and arranged so to be able to accept a DEX/UCS data transfer from the delivery driver's handheld computer and then to communicate or transmit the DEX/UCS delivery information to the retailer's or recipient's computer system using any of a number of techniques known to those skilled in the art including, but not limited, to those techniques embodying wireless (e.g., IR or RF), and non-wireless (e.g., optical cable and twisted strand wire) communications techniques. In particularly preferred embodiments, such delivery information is communicated or transmitted wirelessly using, but not limited to, standard (802.11, 802.11b, 802.11g or 802.11a) radio frequency technology. In further embodiments, the retailer or the retailer's computer system, immediately processes the received delivery information, processes the transaction and then sends a command or instruction along with the appropriate information to the data transfer and communication device so as to thereby cause the data transfer and communication device to print a receipt as proof of delivery for the delivery driver. In further embodiments, the data transfer and communication device is configured and arranged so as to be responsive to commands and instructions communicated from the delivery driver's handheld computer so the delivery driver has the ability to print directly to the data transfer and communication device

The present invention advantageously provides multiple benefits that is more portable, cost effective, removes typical physical limitations, easier to maintain, provides printable proof of delivery receipts, transmits information wirelessly for immediate processing.

In specific embodiments, the data transfer and communication device of the present invention includes a processor, an applications or software program for execution on the processor; a first communications device and a second communications device. The first communication device is operably coupled to the processor and is configured and arranged for communication with a first device, where the first device contains one of data or information for transfer to a second device. The second communication device is operably coupled to the processor and is configured to communicate with the second device, more particularly to communicate with the second device using radio frequency technology.

The applications/software program includes instructions and criteria for controlling operation of the data transfer and communication device and the functionalities thereof, including controlling communications between the processor and the first and second device. In exemplary embodiments, the first device is the delivery driver's handheld computer and the second device is the computer system of the retailer or the recipient of the delivered goods. More particularly, the applications/software program includes instructions and criteria for controlling communications between the first device and the processor including the transmission of the one of data and information from the first device to the processor, and controlling wireless communications between and among the processor and the second device including wireless transmission of said received one of data and information to the second device.

In a further embodiment, the first communication device is configured and arranged so as to establish one of wireless or non-wireless communications between the first device and the wireless printer. The instructions and criteria for controlling communications with the first device further includes instructions and criteria appropriate for the particular communications technique.

In another embodiment, the data transfer and communications device includes a printer and the applications/software program further includes instructions and criteria for receiving input from the second device and for automatically printing a hard copy record of the input received from the second device. In further embodiments, the applications/software program further includes instructions and criteria for receiving other input from the first device via the first communication device and for printing a hard copy record of the input from the first device.

In further embodiments, the first device is a hand held computer and the second device is a computer of a retailer, wherein the one of data and information from the first device includes one of sales delivery, returns, cash receipts, expenses, inventory and inventory transactions and wherein the input from the second device includes a receipt for proof of delivery.

In yet another embodiment, the first communication device includes an RS-232 port and cable for interconnecting the first device and the first communications device. In further embodiments, the first communication device is configured and arrange so as to includes a transmitter or transceiver embodying one of IEEE 802.11, 802.11b, 802.11g or 802.11a transmission standards.

Also featured is a product delivery (e.g., to a retailer) and data transfer method for delivery of product and transferring data related thereto to a computer system. Such a method includes providing an interface device (e.g., a data transfer and communication device) that includes a processor; a first communication device operably coupled to the processor and a second communication device being operably coupled to the processor, coupling a first device operated by a delivery person to the first communication device; and coupling a second device to the second communication device of the wireless interface device using an RF technique. In particular embodiments, the first communication device is coupled to the first device using one of a wireless or non-wireless technique and the second device is coupled to the second communication device using a wireless technique, more specifically an RF technique. Such a method further includes transmitting delivery information representative of a delivery transaction from the first device to the processor; and transmitting the received delivery information representative of a delivery transaction from the processor to the computer system.

In further embodiments, such a product delivery and data transfer method, further includes processing the received delivery information representative of the delivery transaction in the computer system and transmitting information of proof of delivery from the computer system to the interface device. In addition such methods further includes transmitting the proof of delivery information to the first device from the wireless interface device

In another embodiment, the provided interface device further includes a printer and the product delivery and data transfer method of the present invention further includes printing a receipt from the interface device printer as proof of delivery of the product.

In yet another embodiment, the second communication device is operably coupled to a network and the second device also is operably coupled to the network such that communications between the second communication device and the second device are done through the network. In further embodiments the first communication device and the first device are configured and arranged so as to be coupled to and to communicate via the network. In particular embodiments the second communication device is operably coupled to the second device via a wireless access device of the network.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a perspective view of an exemplary illustrative embodiment of a data transfer and communication system of the present invention;

FIG. 2 is a block diagram view of a data transfer and communication device of the present invention; and

FIGS. 3A,B is a flow diagram illustrating a delivery and data transfer method according to the present invention.

### DESCRIPTION OF THE PREFERRED EMBODIMENT

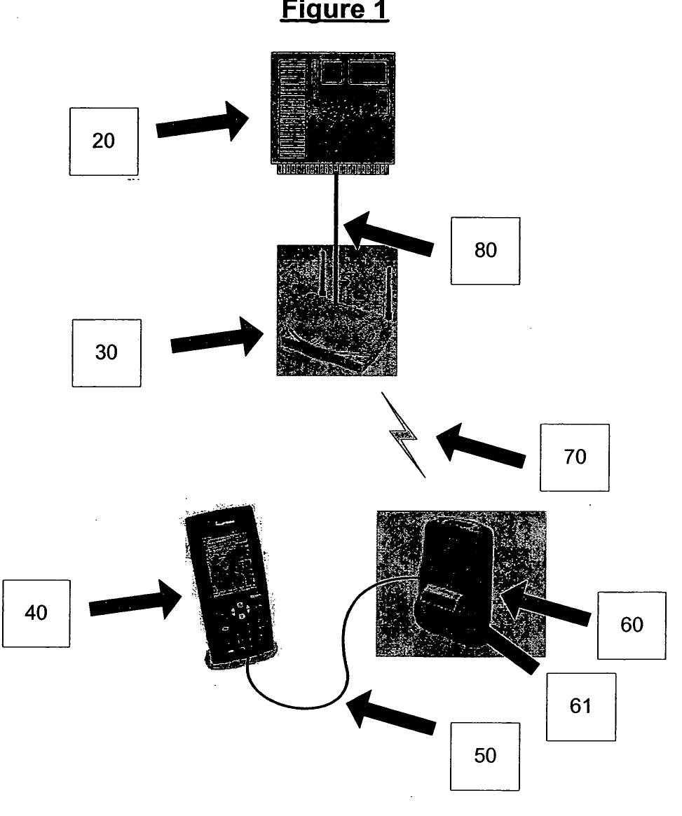

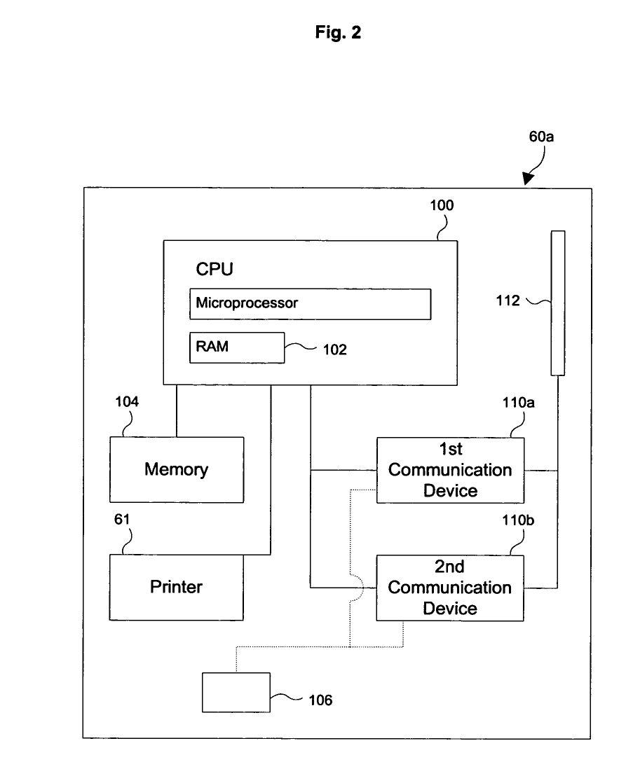

Referring now to the various figures of the drawing wherein like reference characters refer to like parts, there is shown in FIG. 1 a perspective that of an exemplary illustrative embodiment of a data transfer and communication system 10 of the present invention. It is recognized that those skilled in the art based on the teaching of the present invention, can adapt the present invention so as to be useable with any of a number of communications techniques and devices know to those skilled in the art. It also is contemplated that devices known to those skilled in the art, such as for example, mobile wireless printers, can be adapted using the teachings of the present invention so such mobile wireless printers can emulate the characteristics of the data transfer and communication device 60 or interface device of the present invention. There is shown in FIG. 2, a schematic block diagram of an exemplary data transfer and communications device 60a according to an embodiment of the present invention.

In more particular embodiments, the data transfer and communication system 10 of the present invention includes a data transfer and communication device 60 and the communication links or mechanisms (e.g., cables) between the first device 40, e.g., a Handheld Delivery Computer, and the second device 20, for example a computer system of the retailer or the recipient of the goods (e.g., warehouse). In the illustrated embodiment, the first device 40 is coupled to the data transfer communication device 60 by a cable 50 that is coupled to a port 106 of the data communication and transfer device. In alternative embodiments, the first device 40 includes a wireless connection (e.g., Bluetooth, 802.11b, g or a) that couples or connects the first device to a corresponding wireless connection of the data transfer and communication device 60. In the illustrated embodiment, the data transfer and communication device 60 connects to a wireless infrastructure 70 as is known to those skilled in the art that in turn is in communication with a wireless access point 30. The wireless access point 30 is any of a number of devices or apparatuses known to those in the art which embody a wireless communications techniques and which is connectable to another device or to a network 80. The wireless access point 30 is operably coupled to computer system 20 via a connection or network 80 so as to allow communications to occur between the computer system and the data transfer and communication device 60.

The handheld computer comprising the first device 40 or the computer system comprising the second device 20, are each configured and arranged so as to use the printer 61 of the data transfer and communication device 60. In this way, the handheld computer or computer system can use the printing function of the data transfer and communication device 60 for many functions such as receipts for proof of delivery, pricing, labels and returns. Also, the computer system 20 has the ability, but not limited to printing via the wireless access point 30 and wireless infrastructure 70 to the data transfer and communication device 60. The delivery persons' handheld computer also has the ability, but not limited to transmitting the DEX/UCS data over the connection cable 50 to the data transfer and communication device 60 and using the data transfer and communication device to print out from the printer 61 there from.

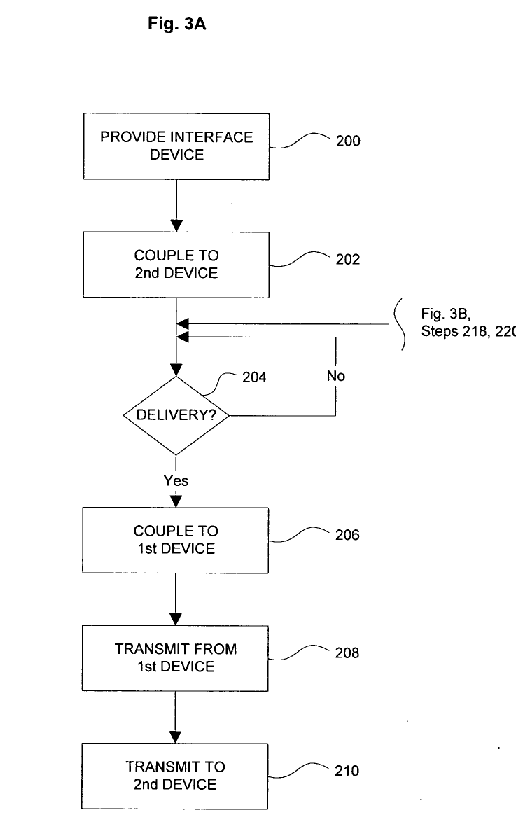

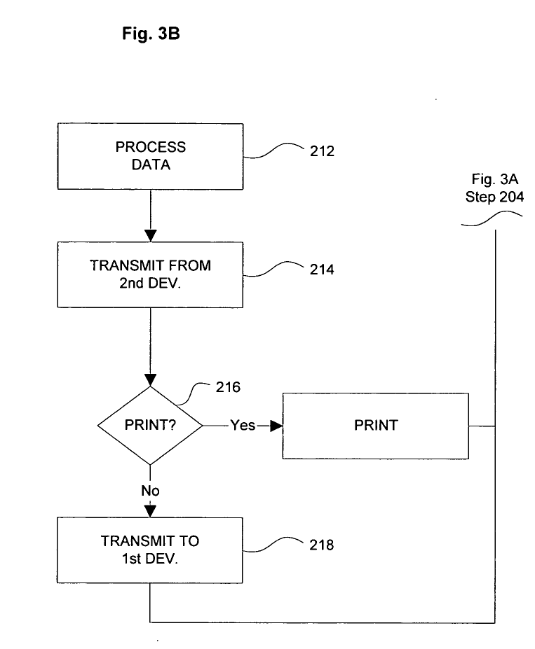

Referring now to FIG. 2, there is shown a schematic block diagram of a data transfer and communication device 60a according to an embodiment of the present invention that includes a processor 100 or central processing unit that includes one or more micro-processors such as those manufactured by Intel or AMD and random access memory (RAM) 102, a memory unit 104, a printer 61 or printing unit, a first communication device 110a and a second communication device 110b, an I/O port 106, and an operating system and/or one or more applications/software programs for execution on the central processing unit. The processor 100 including the RAM 102 and micro-processor are any one of a number of processors, RAM modules and microprocessors known in the art that are appropriate for the intended use. The one or more software applications or programs for execution on the microprocessor are generally provided to otherwise carry out the control, data acquisition and data transmission functions of the data transfer and communication device 60a as herein described (see also FIGS. 3A,B).

The memory unit 104 is any of a number of devices or modules known those skilled in the art for non-volatile storing of information, more particularly any of a number of mediums, devices or modules known to those skilled in the art where data or information remains stored in the medium after power is withdrawn and where data can be removed or erased there from without requiring the replacement of the medium. Such devices include but are not limited to non-volatile storage mediums include flash or spindle types of memory including for example flash memory, nonvolatile random access memory (NVRAM), EEPROM, a hard disk, optical media, and magneto-optical media.

In a particular embodiments, the memory unit 104 is provided for purposes of booting and storing the operating system, storing applications or systems that are to be executed on the computer, paging and swapping between the memory unit and the RAM 102 and the like. In further embodiments, the memory unit 104 also is used for temporary storage of the data and/or information being communicated to/from the data transfer and communications device and the second device 20 or computer system.

The printer 61 is any of a number of devices or units as is known to those skilled in the art that can be used to print a label, delivery receipt and the like. The printer 61 is operably coupled to the processor 100 using any of a number of I/O techniques known to those skilled in the art so as to allow the processor to initiate and control the print function.

The first and second communication devices 110a,b are any of a number of devices known to those skilled in the art for establishing a communications link between systems and/or devices external to the data transfer and communication device 60a using any of a number or wireless (RF or IR) or non-wireless (optical, non-optical) communication techniques. In the illustrated embodiment, the first communication device 110a and the second communication device 110b are shown as being capable of RF wireless communications with the external device(s). In the exemplary embodiment illustrated in FIG. 1, however, the data transfer and communication device 60 is configured so that the first communication device 110a communicates with the first device 40 using non-wireless communication techniques via a port 106.

In FIG. 2, the dotted lines from the port 106 to each of the first and second communication devices 110a,b illustrate a non-wireless connection. As is known to those skilled in the art, there are a number of techniques and/or standards that are utilized for the non-wireless transmission of digitized data, one technique involves the use of an RS232 port, another involves the use of a network connection (e.g., CAT-5 capable), another technique involves the use of what is commonly referred to as a universal serial bus (USB) more particularly as USB 1.0, 2.0 and 2.1, and another embodies IEEE standard 1394, commonly referred to as Firewire. It is within the scope of the present invention to configure the port 106 so as embody any of these communications techniques as well as configuring the first communication device 110a to support such communications. It also is within the scope of the present invention for a plurality or more of ports 106 to be provided to support different non-wireless communication standards as well as configuring the first communication device 110a to support such communications.

In the case where communications with the data transfer and communication device 60a are to be conducted wirelessly, then the each of the respective first and second communication devices 110a,b includes a transceiver that is connected to an antenna 112 and a signal converter. The antenna 112 is any of a number of types and/or shapes of antennas (e.g., loop type) that is appropriate for the intended use and the type of transceiver. The transceiver is any of a number of devices known to those skilled in the art for wireless transmission including wireless network transmission systems or techniques. An exemplary wireless network technique includes those systems embodying a transceiver or transmitter complying with IEEE-802.11 sometimes referred to as Bluetooth chip. In each case, the transceiver is configured and arranged so as to establish a communications link between the respective communication device 110a,b and a remote receiver or transceiver or the infrastructure of a wireless network.

The converter is provided for configuring the digitized data, into the appropriate form for transmission and typically includes a general purpose microprocessor, RAM and one or more software applications or programs for carrying out the conversion. In addition to the conversion functionalities, the converter also can include encryption functionalities, whereby the digitized data is encrypted using any of a number of encryption techniques known to those skilled in the art. It should be recognized that it is within the scope of the present invention for such software applications or programs associated with the converter to be executed on the microprocessor 100 and thus eliminate the need for a separate component.

Referring now to FIGS. 3A,B there is shown a flow diagram illustrating a product delivery and data transfer methodology of the present invention. Reference shall be made to the foregoing discussion regarding FIGS. 1-2 for details regarding the features of the data transfer and communication system 10 and the data transfer and communication device 60, 60a of the present invention not otherwise shown in FIGS. 3A,B. or provided below

The data transfer and communication system 10 is established by providing a data transfer and communication device 60,60b as herein described that includes a first communication device 110a operably coupled to the processor 100 and a second communication device 110b also being operably coupled to the processor, STEP 200. Also, the second communication device 110b is operably coupled using the appropriate techniques and equipment to the communications network 70, and so as to thus operably couple the data transfer and communication device to the second device 20, which in the illustrated embodiment is the computer system of the retailer of the recipient of the goods, STEP 202. For example, the goods can be shipped to a distributor who warehouses the goods for subsequent delivery to their customers.

After establishing the communications links between the data transfer and communication device 60, 60a and the second device 20, the method awaits the delivery of the goods, STEP 204 (NO, STEP 204). When the goods are received thus representing a delivery to the point of delivery (YES, STEP 204), then the delivery person (e.g., delivery driver) operably couples the first device 40, such as a handheld computer that is programmed with the information and data relating to the goods or product being delivered, to the data transfer and communication device 60,60a, STEP 202. More specifically, the delivery person operably couples the first device 20 to the first communication device 110b using one of a wireless or non-wireless technique (e.g., interconnect a cable 50 between the first device 40 and the I/O port 106).

After the communications link is established between the first device 40 and the data transfer and communication device 60,60a, the delivery person initiates the process by which the delivery information is transmitted from the first device 40 to the data transfer and communication device, STEP 208. More particularly, the data is transmitted via the first communication device 110a to the processor 100.

In further embodiments, and following such data transmission or alternatively concurrently with such data transmission, the data transfer and communication device 60,60a transmits the received data/information to the second device 20, the computer system, STEP 210. More particularly, the data is transmitted to the second device 20 via the second communication device 110b, the wireless network, 70, the wireless access point 30 and the network 80 or connection interconnecting the second device and the wireless access point.

After receiving such data/information the second device 20, the computer system, processes the received delivery information that is representative of the delivery transaction, STEP 212. The second device 20, the computer system, then transmits information representative of proof of delivery from the computer system to the data transfer and communication device 60,60a, STEP 214. More particularly, the data is transmitted from the second device 20 via the second communication device 110b, the wireless network, 70, the wireless access point 30 and the network 80 or connection interconnecting the second device and the wireless access point.

In further embodiments, and following receipt of such proof of delivery information, the data transfer and communication device 60,60a, more particularly the processor 100, determines if a receipt of proof of delivery should be printed or if the proof of delivery information should be transmitted to the first device, the handhled computer of the delivery person, STEP 216. If a receipt is to be printed (YES, STEP 216) then the processor 100 implements a print function for the printer 61 and thus causes the proof of delivery receipt to be printed out, STEP 220. If a receipt is to not be printed (NO, STEP 216) then the processor 100 control the first communication device 110a so the proof of delivery information is transmitted/communicated via the communication link to the first device, STEP 220.

In further embodiments, and as indicated herein, the delivery person after coupling the first device, the handheld computer, to the data transfer and communication device 60,60a, can issue instructions to the data transfer and communication device so as to cause a receipt to be printed out locally by the data transfer and communication device.

When the delivery person has completed all actions involved with the delivery of the goods and obtaining the proof of delivery receipts or information, the delivery person disconnects or decouples the first device 40 from the data transfer and communication device 60,60a. For example, the delivery person unplugs the interconnecting cable from the port 106 or logs off the network. Thereafter, the process returns to awaiting the delivery of goods, STEP 204.

Although a preferred embodiment of the invention has been described using specific terms, such description is for illustrative purposes only, and it is to be understood that changes and variations may be made without departing from the spirit or scope of the following claims.

Incorporation by Reference

All patents, published patent applications and other references disclosed herein are hereby expressly incorporated by reference in their entireties by reference.

Equivalents

Those skilled in the art will recognize, or be able to ascertain using no more than routine experimentation, many equivalents of the specific embodiments of the invention described herein. Such equivalents are intended to be encompassed by the following claims.

1. A data transfer and communication device comprising:
a processor;
a first communication device operably coupled to the processor and being configured for communication with a first device, the first device containing one of data or information for transfer to a second device;
a second communication device operably coupled to the processor and being configured to communicate with the second device using radio frequency technology; and
a software program for execution on the processor, the software program including instructions and criteria for:
controlling communications between the first device and the processor including the transmission of the one of data and information from the first device to the processor, and
controlling wireless communications between and among the processor and the second device including wireless transmission of said received one of data and information to the second device.

2. The data transfer and communication device of claim 1, wherein the first communication device is configured and arranged so as to establish one of wireless or non-wireless communications between the first device and the wireless printer.

3. The data transfer and communication device of claim 1, wherein said software program further includes instructions and criteria for receiving input from the second device and for automatically printing a hard copy record of the input received from the second device.

4. The data transfer and communication device of claim 1, wherein the first device is a hand held computer and the second device is a computer of a recipient of product, wherein the one of data and information from the first device includes one of sales delivery, returns, cash receipts, expenses, inventory and inventory transactions and wherein the input from the second device includes a receipt for proof of delivery.

5. The data transfer and communication device of claim 1, wherein the software program, further includes instructions and criteria for receiving other input from the first device via the first communication device and for printing a hard copy record of the input from the first device.

6. The data transfer and communication device of claim 2, wherein the first communication device includes an RS-232 port and cable.

7. The data transfer and communication device of claim 2, wherein the first communication device includes a transmitter embodying one of IEEE 802.11, 802.11b, 802.11g or 802.11a transmission standards.

8. A product delivery and data transfer method for delivery of product to a retailer and transferring data related thereto comprising the steps of:
providing a wireless interface device including a processor; a first communication device operably coupled to the processor and a second communication device being operably coupled to the processor;
coupling the first device operated by a delivery person to the first communication device of the wireless interface device using one of a wireless or non-wireless technique;
coupling the second device to the second communication device of the wireless interface device using an RF technique;
transmitting one of delivery information from the first device to the processor; and
transmitting the received delivery information representative of a delivery transaction from the processor to a computer system of the retailer.

9. The product delivery and data transfer method of claim 8, further including the steps of:
processing the received delivery information representative of the delivery transaction in the retailer computer system; and
wireless transmitting information of proof of delivery from the retailer computer system to the wireless interface device.

10. The product delivery and data transfer method of claim 9, further including the step of transmitting the proof of delivery information to the first device from the wireless interface device

11. The product delivery and data transfer method of claim 9, wherein the wireless interface device further comprises a printer and wherein said method further comprises the step of printing a receipt from the wireless interface device printer as proof of delivery of the product.

12. The wireless printer of claim 1, wherein the second communication device is operably coupled to the second device via a wireless access device of a network.
